(19) United States
(12) Patent Application Publication
(10) Pub. No.: US 2008/0057400 A1
(43) Pub. Date: Mar. 6, 2008

(54) SEPARATOR FOR NON-AQUEOUS ELECTROLYTE BATTERY AND NON-AQUEOUS ELECTROLYTE BATTERY

(75) Inventors: Tetsuo NANNO, OSAKA (JP); Masaki DEGUCHI, HYOGO (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/850,400

(22) Filed: Sep. 5, 2007

(30) Foreign Application Priority Data
Sep. 6, 2006 (JP) 2006-240995

(51) Int. Cl. H01M 2/16

(52) U.S. Cl. 429/254

(57) ABSTRACT

A separator is made by using a copolymer for the separator including a monomer component derived from an olefin compound containing a fluorine atom and a monomer component derived from a polymerizable organic compound containing an oxygen atom in its molecule. This separator is excellent in resistance to oxidation and wettability to electrolytes. Therefore, by making a non-aqueous electrolyte battery using this separator, charge and discharge cycle life and storage characteristics of the battery improve. Further, similar effects can be obtained by using this separator, even in the case of a non-aqueous electrolyte battery using a high-potential positive electrode active material.

### FIELD OF THE INVENTION

The present invention relates to separators for non-aqueous electrolyte battery and to non-aqueous electrolyte batteries.

### BACKGROUND OF THE INVENTION

With the downsizing trend of electronic devices, batteries having high energy density are demanded as a main power source and a backup power source for those devices. Particularly, lithium non-aqueous electrolyte batteries are gaining attention, due to their high voltage and high energy density compared with conventional aqueous solution-type batteries with the electrolyte of an aqueous solution of supporting salt. There has been active development for an electrode active material that enables high capacity batteries, and for an electrode active material that enables high voltage batteries, aiming for further higher energy density in lithium non-aqueous electrolyte batteries. Particularly, among electrode active materials, LiMn_{1.5}Ni_{0.5}O₄, i.e., a spinel-type lithium compound, and LiCoPO₄, i.e., an olivine-type lithium compound, are gaining attention as positive electrode active materials achieving a high voltage of 5 V class (hereinafter referred to as “high-potential positive electrode active material”). However, there are some problems in using such high-potential positive electrode active materials. Charge and discharge cycle life and storage characteristics of batteries decline.

Separators also have to be examined for a further higher energy density in non-aqueous electrolyte batteries. As conventional separators for non-aqueous electrolyte batteries, porous resin films comprising generally polyolefins such as polypropylene and polyethylene and having micropores therein are known. Porous resin films have self-closing characteristics, by which micropores thereof are closed when heated to high temperature.

For example, Japanese Laid-Open Patent Publication No. Hei 5-74436 proposed a 3-layer structure separator, in which a composite nonwoven fabric comprising polypropylene and polyethylene, a middle layer, and the same composite nonwoven fabric are layered. The middle layer is a porous resin film containing a resin with a low melting point, i.e., a softening temperature of 95 to 160° C. A specific example of such a low melting point resin is mentioned in paragraph [0023] of JP Hei 5-74436, i.e., polyolefins such as a low density polyethylene, an chain low density polyethylene, and a high density polyethylene. In this separator, the micropores of the middle layer are closed upon abnormal heat generation in the battery to block ions from penetrating for stopping the heat generation, in an attempt to ensure battery safety.

However, polypropylene and polyethylene used for the middle layer can be further improved, in terms of resistance to oxidation. When used for a long period of time, it is highly possible that the middle layer is deteriorated by oxidation. The middle layer deterioration declines charge and discharge cycle life and storage characteristics of batteries.

Japanese Laid-Open Patent Publication No. 2000-21451 proposes a separator including polytetrafluoroethylene, polyethylene, and a ceramics material such as silicon dioxide. This separator is not easily oxidized due to its polytetrafluoroethylene content. However, since the surface energy of polytetrafluoroethylene is small and its wettability to electrolytes is low, the internal resistance of batteries increases, and as a result, discharge performance of batteries declines.

Japanese Laid-Open Patent Publication No. Hei 9-306460 proposes a separator using a combination of a polyolefin porous film having element composition ratios at surface of 0.002<F/C<0.4 and 0.005<O/C<5, and a polyolefin nonwoven fabric having element composition ratios at surface of 0.01<F/C<0.6 and 0.01<O/C<5. This separator is excellent in self-closing characteristics, retains its film form well at high temperature, and has good wettability to electrolytes. The surface of the separator is insufficiently fluorinated, and therefore its oxidation resistance can be improved still further. Charge and discharge cycle life, and storage characteristics of batteries are inevitably declined.

Japanese Laid-Open Patent Publication No. 2002-302650 proposes a film-forming agent including an effective component, i.e., compound (A) represented by the general formula:

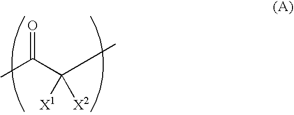

where X¹ and X² are halogens or a perfluoroalkyl group having one to ten carbons. This film-forming agent is added to the electrolyte, and contacts the negative electrode to form a film on the negative electrode surface. This improves thermal stability and safety of the battery. However, since the negative electrode surface film does not function as separators, by forming this film, the negative electrode and the separator are disposed with the film interposed therebetween. As a result, sufficient battery performance may not be obtained. Also, JP 2002-302650 does not describe copolymerizing compound (A) with olefin, and using the obtained copolymer as the separator material.

Further, U.S. Pat. No. 2,495,286 discloses in its specification a copolymer of perfluoroolefin and carbon monoxide, and a method for synthesizing the copolymer. However, U.S. Pat. No. 2,495,286 does not describe using this copolymer for the separator material. Also, there is no description as to achieving excellent effects of improving charge and discharge cycle life and storage characteristics of batteries when used as the separator.

### BRIEF SUMMARY OF THE INVENTION

The present invention aims to provide a separator for non-aqueous electrolyte batteries: the separator is excellent in resistance to oxidation, wettability to electrolytes, and self-closing characteristics; has a high mechanical strength; and keeps its shape excellently.

The present invention also aims to provide a non-aqueous electrolyte battery, which has a high voltage and a high energy density; is excellent in charge and discharge cycle life and storage characteristics; and keeps charge and discharge cycle life and storage characteristics at a high-level even used for a long period of time.

The present invention provides a separator for non-aqueous electrolyte batteries. The separator includes a resin film including a copolymer containing an olefin compound containing a fluorine atom in its molecule (hereinafter referred to as “fluorine-containing olefin compound”); and a polymerizable organic compound containing an oxygen atom in its molecule (hereinafter referred to as “oxygen-containing polymerizable compound”).

The copolymer preferably contains at least one carbonyl group in its molecule. The carbonyl group is particularly effective in improving copolymer wettability to electrolytes.

A hydrogen atom is preferably not bound to the α-position atom adjacent to the carbon atom of the carbonyl group.

In the copolymer, a hydrogen atom is preferably not bound to the carbon atom in the main-chain.

The fluorine-containing olefin compound is preferably perfluoroolefin, and the oxygen-containing polymerizable compound is preferably carbon monoxide.

In the copolymer, the fluorine-containing olefin compound at the terminal position is preferably perfluoroolefin. The perfluoroolefin is preferably tetrafluoroethylene.

The present invention also provides a non-aqueous electrolyte battery including the separator for non-aqueous electrolyte batteries mentioned above.

The present invention achieves providing a separator for non-aqueous electrolyte batteries: the separator is excellent in resistance to oxidation, affinity for electrolytes (wettability to electrolytes), and self-closing characteristics; has a high mechanical strength; and keeps its shape excellently. Further, by using this separator for non-aqueous electrolyte batteries, the present invention provides a non-aqueous electrolyte battery having a high voltage and a high energy density, and excellent in long-term durability, safety, and reliability. Additionally, the effects of the separator for non-aqueous electrolyte batteries of the present invention do not decline even used for a non-aqueous electrolyte battery using a high-potential positive electrode active material.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWING

FIG. 1 is a longitudinal sectional view schematically showing the structure of a non-aqueous electrolyte battery 1 according to one embodiment of the present invention.

### DETAILED DESCRIPTION OF THE INVENTION

### [Separator for Non-aqueous Electrolyte Batteries]

A separator for non-aqueous electrolyte batteries based on the present invention includes a resin film containing a specific copolymer for separators. The specific copolymer for separators is a copolymer of a fluorine-containing olefin compound and an oxygen-containing polymerizable compound. The copolymer includes radical copolymers, block copolymers, and graft copolymers.

In the copolymer used for the separator of the present invention, the oxidation number of the carbon atom in its molecule is high. With the high oxidation number of the carbon atom, a further oxidation of the carbon atom will be logically few. The state of the carbon atom with the high oxidation number continues stably. Accordingly, the copolymer is not easily oxidized, and its resistance to oxidation improves. Also, the copolymer used for the separator of the present invention includes a highly polar functional group containing an oxygen atom, such as a carbonyl group. Accordingly, wettability to electrolyte improves.

Specific examples of the copolymer used for the separator of the present invention include, for example, fluoroalkylether represented by the general formula

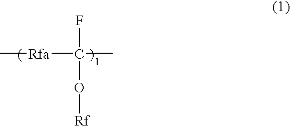

where Rf is a fluoroalkyl group, Rfa is a fluoroalkylene group, and l is a natural number (hereinafter referred to as “fluoroalkylether (1)”); and

a carbonyl group-containing fluoropolyolefin represented by the general formula

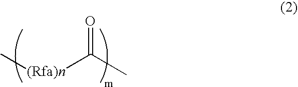

where Rfa is the same as the above, and m and n are natural numbers (hereinafter referred to as “fluoropolyketone (2)”.

In the above general formula (1), the natural number represented by l is preferably 500 to 1000000. Additionally, in the above general formula (2), the natural number represented by m is preferably 500 to 1000000. The natural number represented by n is preferably 1 to 20.

In the above general formula (1), the fluoroalkyl group represented by Rf includes, for example, a straight-chain or branched-chain perfluoroalkyl group having 1 to 20 carbon atoms such as CF₃, C₂F₅, n-C₃F₇, iso-C₃F₇, n-C₄F₉, iso-C₄F₉, sec-C₄F₉, tert-C₄H₉, CF₃(CF₂)ₐ (a is an integer from 4 to 19), and (CF₃)₂CFCF₂)_{b} (b is an integer from 2 to 17); and a straight-chain or branched-chain polyfluoroalkyl group having 1 to 20 carbon atoms such as CHF₂(CF₂)_{c} (c is an integer from 1 to 5), and CH₂F(CF₂)ₐ (a is the same as the above).

Additionally, in the above general formulae (1) and (2), the fluoroalkylene group represented by Rfa includes, for example, a straight-chain or branched-chain fluoroalkylene group having, 1 to 20 carbon atoms, such as —CF₂—, —C₂F₄—, —CF₂CF₂CF₂—, —CF(CF₃)CF₂—, —CF₂CF₂CF₂CF₂—, —CF(CF₃)CF₂CF₂—, —CF₂CF(CF₃)CF₂—, —(CF₂)ₕ— (h is an integer from 5 to 20), —CF₂CF(CF₃)(CF₂)ⱼ— (j is an integer from 2 to 17), —CF(CF₃)(CF₂)ₖ— (k is an integer from 3 to 18), —CH₂CF₂—, —CF₂CF(C₂H₅)—, and —CH₂CHF— may be mentioned. Among these, the straight-chain or branched-chain perfluoroalkylene group having 1 to 20 carbon atoms is preferable, and the straight-chain perfluoroalkyl group having 1 to 4 carbon atoms are particularly preferable.

Fluoropolyketone (2) is a copolymer of fluoroolefin and carbon monoxide. When fluoroolefin and carbon monoxide are reacted in 1:1 ratio, the value of x is 1, but when fluoropolyketone (2) is synthesized by radical polymerization, x is generally larger than 1.

The copolymer used for the separator of the present invention mainly contains carbon atoms, fluorine atoms, and oxygen atoms. Carbon atoms function, for example, to form the main framework of the copolymer for the separator. Fluorine atoms function, for example, to improve resistance to oxidation of the copolymer for the separator. Oxygen atoms function, for example, to improve wettability of the copolymer for the separator to electrolytes.

The ratio of the fluorine atom content to the carbon atom content (fluorine atom content/carbon atom content, a molar ratio) is preferably 0.5 or more, and the fluorine atom content is further preferably the same amount or more with the carbon atom content. When the ratio of the fluorine atom content and the carbon atom content is below 0.5, the proportion of the carbon-hydrogen bond contained relatively increase. The carbon-hydrogen bond is inferior to the resistance to oxidation, thus declining the resistance to oxidation of the copolymer for the separator as a whole. Additionally, the copolymer for the separator largely includes saturated hydrocarbon patrs containing fluorine atoms, and therefore can be represented by the compositional formula: CₚH_{2p+2-q}F_{q}Oᵣ (where p, q, and r are natural numbers). The copolymer for the separator is a high molecular compound, and from its very large molecular weight, p, which is almost equal to the degree of polymerization of the copolymer for the separator, is sufficiently larger than 2. Therefore, the compositional formula can be represented by a simplified form, i.e., CₚH_{2p-q}F_{q}Oᵣ. When the degree of polymerization is adjusted so that p≦q is satisfied, the fluorine atom content can be made the same with or larger than the carbon atom content. Thus, oxidation of the separator resin due to the detachment of a hydrogen atom from a carbon atom to make carbon atoms prone to oxidation can be reduced greatly.

The ratio of the oxygen atom content to the carbon atom content (oxygen atom content/carbon atom content, a molar ratio) is preferably 0.05 or more. When the ratio of the oxygen atom content to the carbon atom content is below 0.05, due to the relatively less interaction between oxygens and the electrolyte, the improvement effect of the wettability of the separator including the copolymer for the separator to the electrolyte may be decreased. A radical copolymer in which a fluorine-containing olefin compound and an oxygen-containing polymerizable compound are alternately polymerized in 1:1 ratio (molar ratio) has the highest wettability to electrolytes.

Oxygen atoms are preferably contained in the copolymer for the separator in a functional group form. Various functional groups containing oxygen atoms are known, for example, the alkoxy group, the ether group, the carbonyl group, the oxo group, the hydroxyl group, and the carboxyl group may be mentioned. Among these, the carbonyl group is preferable. By including the carbonyl group in the copolymer for the separator, the wettability of the copolymer to electrolytes can be drastically improved. The copolymer for the separator may also be called polyketone, by including a plurality of carbonyl groups. Since polyketones are highly crystallized, when a separator is made by using polyketones, the mechanical strength of the separator improves, and possibility of a battery internal short-circuit can be reduced greatly.

When the copolymer for the separator contains a carbonyl group, a hydrogen atom is preferably not bonded to the α-position atom adjacent to the carbon atom forming the carbonyl group (C═O). Since the hydrogen atom bonded to the α-position atom has a high acidity, it is highly possible that the copolymer for the separator is modified by the aldol condensation as shown in the chemical reaction formula below. Polyhydric alcohol produced by the aldol condensation is prone to be converted to olefin by dehydration. Water produced upon dehydration may cause various inconveniences by becoming water vapor in the battery. Further, in view of resistance to a trace amount of impurities included in the electrolyte, it is preferable that a hydrogen atom is not bonded to the α-position atom adjacent to the carbonyl group. Such a copolymer can be obtained, for example, by polymerizing carbon monoxide and a fluorine-containing olefin compound in which terminal carbon atoms are not replaced with hydrogen atoms.

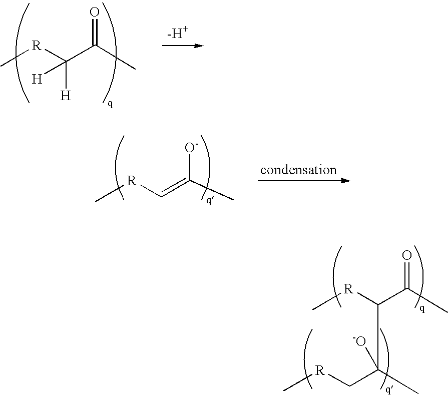

(in the formula, R represents an alkylene group. q and q′ represent natural numbers.)

Also, in the copolymer for the separator used in the present invention, a hydrogen atom is preferably not bonded to carbon atoms in the main-chain. Hydrogen atoms bonded to carbon atoms also have high acidity, and cause the condensation reaction and the dehydration reaction same as the above. Such a copolymer can be obtained, for example, by copolymerizing perfluoroolefin and carbon monoxide. In the present invention, particularly, it is more preferable that hydrogen atoms are not bonded to α-position atoms adjacent to carbon atoms of the carbonyl group (C═O) included in the copolymer, and hydrogen atoms are not bonded to carbon atoms in the main-chain of the copolymer.

In the copolymer for the separator used in the present invention, its terminals are preferably replaced with olefin, further preferably replaced with perfluoroolefin, and particularly preferably replaced with tetrafluoroethylene. When its terminals are replaced with olefin, the effects of improving wettability to electrolyte due to the carbonyl group are sufficiently brought out. When the terminals are replaced with a group other than olefin, the group may hinder the effects due to the carbonyl group from being brought out, and the wettability improvement effects may not be sufficient.

The copolymer for the separator used in the present invention may be made, for example, by copolymerizing a fluorine-containing olefin compound and an oxygen-containing polymerizable compound. For the fluorine-containing olefin compound, may be used are, for example, tetrafluoroethylene, hexafluoropropylene, 1,1-difluoroethylene, 1,1,2-trifluoro-1-butene, vinyl fluoride, vinylidene fluoride, trifluoroethylene, and octafluoroisobutene. Among these, perfluoroolefins such as tetrafluoroethylene and hexafluoropropylene are preferable. The fluorine-containing olefin compound may be used singly, or may be used in combination of two or more. For the oxygen-containing polymerizable compound, may be used are, for example, carbon monoxide, diperfluoroalkylketones, and perfluoro(alkylvinylether). For diperfluoroalkylketones, for example, diperfluoromethylketone, diperfluoroethylketone, and diperfluoropropylketone may be mentioned. For perfluoro(alkylvinylether), for example, perfluoro(methylvinylether), perfluoro(ethylvinylether), and perfluoro(n-propylvinylether) may be mentioned. Among these, carbon monoxide is particularly preferable. The oxygen-containing polymerizable compound may be used singly, or may be used in combination of two or more. The combination of perfluoroolefins and carbon monoxide is particularly preferable.

By copolymerizing a fluorine-containing olefin compound with carbon monoxide, and diperfluoroalkylketones, fluoropolyketone (2) is obtained. By polymerizing a fluorine-containing olefin compound and perfluoro(alkylvinylether), fluoroalkylether (1) is obtained.

A fluorine-containing olefin compound and an oxygen-containing polymerizable compound may be polymerized by a known method. For example, a radical polymerization, by which a polymerization is carried out under a presence of a radical polymerization catalyst; a photo polymerization, by which a polymerization is carried out under a presence of photo polymerization initiator and/or under irradiation by γ-ray; and a chemical polymerization using a transition metal complex catalyst may be mentioned. The copolymerization of perfluoroolefins and carbon monoxide may be carried out, for example, in a carbon monoxide atmosphere, as described in U.S. Pat. No. 2,495,286. Upon the polymerization, any of the radical polymerization, the photo polymerization, and the chemical polymerization mentioned above may be used.

The separator of the present invention may be made by a known method, using the copolymer for the separator mentioned above. For example, a porous resin film separator of the present invention may be obtained by, applying a shearing force to the copolymer for the separator with an extruder under heat to melt the copolymer for the separator, molding the melted material to a wide and thin film by allowing the melted material to go through a T-die, and immediately cooling the obtained thin film. The thin film thus obtained may be further drawn. The drawing may be carried out, for example, by uniaxially drawing, successive or simultaneous biaxial drawing, continuous successive biaxial drawing, and continuous simultaneous biaxial drawing such as continuous tenter clip method. A plurality of the thin films obtained by such a method may be stacked, heated, and melted to integrate, for the use as a separator of the present invention.

In the production method mentioned above, to the melted copolymer for the separator, an organic powder or an inorganic powder may be added. These powders are homogenously dispersed in the melted copolymer. By using the melted copolymer for the separator including these powders for making the separator in the same manner as the above, and carrying out appropriate treatment according to the powder type, the separator can be made further porous. For example, by making a separator including an organic powder, and allowing an organic solvent to contact the separator, the organic powder is removed from the separator. Thus, a separator of the present invention with further increased porosity can be obtained. For the organic powder, for example, a plasticizer such as dioctyl phthalate, sebacic acid, adipic acid, and trimellitic acid may be mentioned. For the organic solvent to remove the organic powder, those organic solvents that do not dissolve the copolymer for the separator but dissolve the organic powder may be selected appropriately.

Also, by making a separator including an inorganic powder and allowing water to contact the separator, the inorganic powder is removed. Thus, a separator of the present invention with a further increased porosity can be obtained. For the inorganic powder, for example, calcium carbonate, magnesium carbonate, and calcium oxide may be mentioned.

The separator of the present invention may be woven fabric or nonwoven fabric. That is, the copolymer for the separator is made into fibers by a known method, and the obtained fibers are used to make woven fabric and nonwoven fabric. Nonwoven fabric is particularly preferable, and nonwoven fabric obtained by the melt-blown method is further preferable. The melt-blown method is carried out, for example, by using an extruder including a spinning hole, a slit, and a collecting face. The spinning hole refers to a plurality of mouthpieces for discharging a melted resin such as T-die provided in a width direction thereof. From the spinning hole, a melted resin having the form of the mouthpiece is discharged. The slit is provided next to the both sides of the mouthpiece, and a blast of a high-temperature gas is applied with a high-speed to the melted resin discharged from the spinning hole. Thus, the melted resin is finely chopped, so that extra-fine fiber is obtained. The collecting face is movable, and has air permeability. By piling up the extra-fine fiber on the collecting face, nonwoven fabric is obtained. This nonwoven fabric may be used as a separator of the present invention as it is. Or, a pressure is further applied with or without heat to this nonwoven fabric for making the fabric into a thin film, and the obtained porous resin film may be used as a separator of the present invention.

Also, at least one conventionally used separator and at least one separator including the above copolymer for the separator may be laminated to obtain a multi-layered structure, to be used as a separator for the present invention.

### [Non-Aqueous Electrolyte Battery]

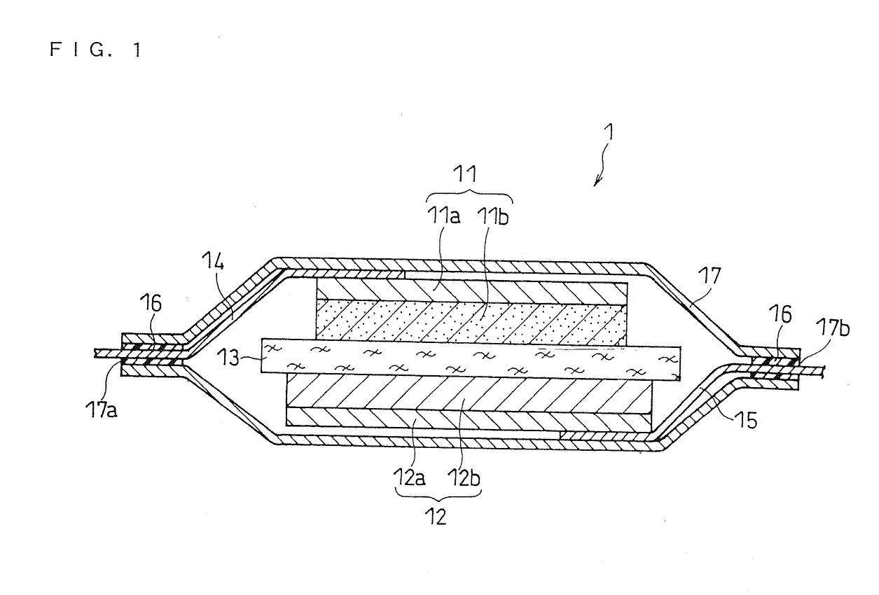

A non-aqueous electrolyte battery of the present invention includes a separator of the present invention. Other than the separator, the battery may be formed as a conventional non-aqueous electrolyte battery. FIG. 1 is a longitudinal sectional view schematically showing the structure of a non-aqueous electrolyte battery 1 according to one embodiment of the present invention. The non-aqueous electrolyte battery of the present invention includes, a positive electrode 11, a negative electrode 12, a separator 13, a positive electrode lead 14, a negative electrode lead 15, a gasket 16, an aluminum laminate bag 17, and a non-aqueous electrolyte.

The positive electrode 11 includes, for example, a positive electrode core material 11a and a positive electrode active material layer 11b. For the positive electrode core material 11a, a core material usually used in the field of non-aqueous electrolyte batteries may be used. For example, a porous or non-porous conductive substrate may be mentioned. For the material forming the conductive substrate, for example, metal materials such as stainless steel, titanium, and aluminum; and a conductive resin may be used. The positive electrode core material 11a is preferably a foil, a sheet, or a film, and further preferably a long foil, a long sheet, and a long film. When the positive electrode core material 11a is a foil, a sheet, or a film, although its thickness is not particularly limited, the thickness is preferably 1 to 50 μm, and further preferably 5 to 20 μm. By setting the thickness within this range, the strength of the positive electrode 11 can be kept high, while the positive electrode 11 can be made lighter.

The positive electrode active material layer 11b is carried on one side or on both sides of the positive electrode core material 11a in the thickness direction thereof. The positive electrode active material layer 11b includes a positive electrode active material, and as necessary, a binder and a conductive agent. The positive electrode active material layer 11b is formed, for example, by applying a positive electrode material mixture slurry on the positive electrode core material surface, and drying the slurry. The positive electrode material mixture slurry is a liquid material in which a positive electrode active material, and as necessary, a binder and a conductive agent are dissolved or dispersed in an organic solvent.

For the positive electrode active material, positive electrode active materials usually used in the field of non-aqueous electrolyte batteries may be used. For example, when the non-aqueous electrolyte battery 1 is a lithium non-aqueous electrolyte battery, a lithium composite metal oxide is preferably used. For the lithium composite metal oxide, for example, LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMePO₄, and Li₂MePO₄F (M=at least one of Na, Mg, Sc, Y, Mn, Fe, Co, Ni, Cu, Zn, Al, Cr, Pb, Sb, and B) may be mentioned. In the above, x=0 to 1.2, y=0 to 0.9, and z=2.0 to 2.3. The value x illustrating the molar ratio is the value immediately after the positive electrode active material is synthesized, and changes upon charge and discharge. Further, a portion of the lithium composite metal oxide may be replaced with a different element. The surface of the lithium composite metal oxide may be treated with a metal oxide, a lithium oxide, or a conductive agent. The surface of the lithium composite metal oxide may also be treated to give hydrophobicity. The positive electrode active material may be used singly, or may be used in combination of two or more. The amount of the positive electrode active material is not particularly limited, but when a binder and a conductive agent are used along with the positive electrode active material, the amount is set to 80 to 97 wt % of the total of the positive electrode active material, the binder, and the conductive agent.

For the binder, may be used are, for example, polyvinylidene fluoride (PVDF), polytetrafluoroethylene, polyethylene, polypropylene, aramid resin, polyamide, polyimide, polyamide-imide, polyacrylnitrile, polyacrylic acid, polyacrylic acid methylester, polyacrylic acid ethylester, polyacrylic acid hexylester, polymethacrylic acid, polymethacrylic acid methylester, polymethacrylic acid ethylester, polymethacrylic acid hexylester, polyacetic acid vinyl, polyvinylpyrrolidone, polyether, polyethersulfone, hexafluoropolypropylene, styrenebutadiene rubber, and carboxymethylcellulose. For the binder, a copolymer of two or more monomer compounds selected from tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene may be used. The binder may be used singly, or may be used in combination of two or more. The amount of the binder to be used is not particularly limited, but when the binder and the conductive agent are used along with the positive electrode active material, the amount of the binder is appropriately selected from the range of about 2 to 7 wt % relative to the total of the positive electrode active material, the binder, and the conductive agent.

For the conductive agent, for example, may be used are graphites such as natural graphite and artificial graphite; carbon blacks such as acetylene black, ketjen black, channel black, furnace black, lamp black, and thermal black; conductive fibers such as carbon fiber and metal fiber; metal powders such as aluminum and fluorocarbon; conductive whiskers such as zinc oxide whisker and potassium titanate whisker; a conductive metal oxide such as titanium oxide; and an organic conductive material such as phenylene derivative. The conductive agent may be used singly, or may be used in combination of two or more. The amount of the binder to be used is not particularly limited, but when the positive electrode active material is used along with the binder and the conductive agent, the amount may be selected from the range of about 1 to 20 wt % relative to the total of the positive electrode active material, the binder, and the conductive agent.

The negative electrode 12 includes, for example, a negative electrode core material 12a and a negative electrode active material layer 12b. For the negative electrode core material 12a, the negative electrode core material usually used in the field of non-aqueous electrolyte batteries may be used. For example, a porous or non-porous conductive substrate may be mentioned. For the material forming the conductive substrate, for example, metal materials such as stainless steel, nickel, and copper; and a conductive resin may be used. The negative electrode core material 12a may be in a form of foil, sheet, and film, and further preferably, a long foil, a long sheet, and a long film. When the negative electrode core material 12a is a foil, a sheet or a film, its thickness is not particularly limited, but preferably 1 to 50 μm, and further preferably 5 to 20 μm. By setting the thickness within this range, the negative electrode strength can be kept high, while making the negative electrode weight light.

The negative electrode active material layer 12b is carried on one side or on both sides of the negative electrode core material 12a in the thickness direction thereof. The negative electrode active material layer 12b includes a negative electrode active material, and a binder and a conductive agent may further be included depending upon the type of the negative electrode active material. For example, the negative electrode active material layer 12b may be formed by vapor depositing the negative electrode active material on the negative electrode core material surface. The negative electrode active material layer 12b may also be formed by applying a negative electrode material mixture slurry on the negative electrode core material surface and drying the slurry. The negative electrode material mixture slurry is a liquid material in which a negative electrode active material, and as necessary a binder and a conductive agent are dissolved or dispersed in an organic solvent.

For the negative electrode active material, those negative electrode active materials usually used in the field of non-aqueous electrolyte batteries may be used. When the non-aqueous electrolyte battery is lithium non-aqueous electrolyte batteries, for example, metals, metal fibers, carbon materials, silicon compounds, tin compounds, oxides, nitrides, and various alloy materials may be used. For the carbon material, for example, various natural graphites, cokes, carbon fiber, spherical carbon, various artificial graphites, and amorphous carbon may be mentioned. For the silicon compound, for example, silicon; silicon oxides such as SiOₜ (0.05<t<1.95); a silicon-containing alloy or a silicon-containing compound in which a portion of Si in silicon or silicon oxide thereof is replaced with at least one element selected from the group consisting of B, Mg, Ni, Ti, Mo, Co, Ca, Cr, Cu. Fe, Mn, Nb, Ta, V, W, Zn, C, N, and Sn; and a solid solution of these may be mentioned. For the tin compound, tin, tin oxides such as SnO₂ and SnOᵤ (0<u<2), and a tin-containing alloy or a tin-containing compound such as Ni₂Sn₄, Mg₂Sn, SnSiO₃, and LiSnO may be mentioned. Among these, considering a large capacity density, a silicon compound and a tin compound are preferable. The negative electrode active material may be used singly, or may be used in combination of two or more.

When the negative electrode active material layer 12b includes a binder along with the negative electrode active material, the same binder used upon forming the positive electrode active material layer may be used. Although the amounts of the negative electrode active material and the binder are not particularly limited, the amount of the negative electrode active material may be selected appropriately from the range of 93 to 99 wt %, and the amount of the binder may be selected appropriately from the range of 1 to 7 wt % relative to the total amount of the negative electrode active material and the binder. When the negative electrode active material layer 12b includes a binder and a conductive agent along with the negative electrode active material, the same binder and conductive agent used upon forming the positive electrode active material layer 12b may be used. The amounts of the negative electrode active material, the binder, and the conductive agent are not particularly limited, but the amount of the negative electrode active material may be appropriately selected from the range of 68 to 97 wt %, the amount of the binder may be appropriately selected from the range of 2 to 7 wt %, and the amount of the conductive agent may be appropriately selected from the range of 1 to 25 wt % relative to the total amount of the negative electrode active material, the binder, and the conductive agent.

The separator 13 is disposed between the positive electrode active material layer 11b of the positive electrode 11 and the negative electrode active material layer 12b of the negative electrode 12, and sandwiched between the positive electrode 11 and the negative electrode 12. For the separator 13, the separator of the present invention described above may be used. The thickness of the separator 13 is not particularly limited, but preferably about 5 to 100 μm. The separator porosity is not particularly limited, but preferably 30 to 70%.

The non-aqueous electrolyte mainly penetrates into or is carried by the separator 13. For the non-aqueous electrolyte, those non-aqueous electrolytes used in the field of non-aqueous electrolyte batteries may be used. For example, a liquid non-aqueous electrolyte, a gelled non-aqueous electrolyte, and a solid non-aqueous electrolyte (solid polymer electrolyte) may be mentioned.

The liquid non-aqueous electrolyte includes a supporting salt (electrolyte) and a non-aqueous solvent, and further includes various additives as necessary.

For the supporting salt, those supporting salts usually used in the field of non-aqueous electrolyte batteries may be used. When the non-aqueous electrolyte battery is a lithium non-aqueous electrolyte battery, for example, for the supporting salt, LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, chloroboran lithium, borates, and imide salts may be used. For the borates, bis(1,2-benzenedioleate(2-)-O,O′)lithium borate, bis(2,3-naphthalenedioleate(2-)-O,O′)lithium borate, bis(2,2′-biphenyldioleate(2-)-O,O′)lithium borate, and bis(5-fluoro-2-olato-1-benzenesulfonate-O,O′)lithium borate may be mentioned. For the imide salt, lithium bistrifluoromethanesulfonate imide ((CF₃SO₂)₂NLi), lithium trifluoromethanesulfonate nonafluorobutanesulfonate imide (LiN(CF₃SO₂)(C₄F₉SO₂)), and lithium bispentafluoroethanesulfonate imide ((C₂F₅SO₂)₂NLi) may be mentioned. The supporting salt may be used singly, or may be used in combination of two or more. The amount of the supporting salt dissolved relative to the non-aqueous solvent is not particularly limited, but preferably selected appropriately from the range of 0.5 to 2 mol/L.

For the non-aqueous solvent, those non-aqueous solvents usually used in the field of non-aqueous electrolyte batteries may be used. For example, cyclic carbonic acid ester, chain carbonic acid ester, and cyclic carboxylic acid ester may be mentioned. For the cyclic carbonic acid ester, propylene carbonate (PC) and ethylene carbonate (EC) may be mentioned. For the chain carbonic acid ester, diethyl carbonate (DEC), ethyl methyl carbonate (EMC), and dimethylcarbonate (DMC) may be mentioned. For the cyclic carboxylic acid ester, γ-butyrolactone (GBL) and γ-valerolactone (GVL) may be mentioned. The non-aqueous solvent may be used singly, or may be used in combination of two or more.

For the additive, for example, materials that improve charge and discharge efficiency, and materials that deactivate batteries may be mentioned. For example, the material that improves charge and discharge efficiency decomposes on the negative electrode to form a film with high ion conductivity, thereby achieving improvement in charge and discharge efficiency. Materials that can improve charge and discharge efficiency include, for example, vinylene carbonate (VC), 3-methylvinylene carbonate, 3,4-dimethylvinylene carbonate, 3-ethylvinylene carbonate, 3,4-diethylvinylene carbonate, 3-propylvinylene carbonate, 3,4-dipropylvinylene carbonate, 3-phenylvinylene carbonate, 3,4-diphenylvinylene carbonate, vinylethylene carbonate (VEC), and divinylethylene carbonate. Among these, vinylene carbonate, vinylethylene carbonate, and divinylethylene carbonate are preferable. In these compounds, hydrogen atoms thereof may be partially replaced with a fluorine atom. The material that improves charge and discharge efficiency may be used singly, or may be used in combination of two or more.

The material that deactivates batteries deactivates batteries for example, by decomposing at the time of overcharge to form a film on the electrode. For the materials that deactivate batteries, for example, a benzene compound including the phenyl group, and a benzene compound including the phenyl group and the cyclic compound group adjacent to the phenyl group may be mentioned. For the cyclic compound group, for example, the phenyl group, the cyclic ether group, the cyclic ester group, the cycloalkyl group, and the phenoxy group are preferable. Specific examples of the benzene compound include, for example, cyclohexyl benzene (CHB) and its modified compound, and biphenyl and diphenylether may be mentioned. These may be used singly, or may be used in combination of two or more. However, the benzene compound content in a liquid non-aqueous electrolyte is preferably 10 wt % or less in the total amount of the non-aqueous solvent.

Gelled non-aqueous electrolytes include a liquid non-aqueous electrolyte and a polymeric material that retains the liquid non-aqueous electrolyte. The polymeric material used here gelatinizes a liquid material. For the polymeric materials, those polymeric materials usually used in this field may be used. For example, polyvinylidene fluoride, polyacrylonitrile, polyethyleneoxide, polyvinyl chloride, polyacrylate, and polyvinylidenefluoride may be mentioned.

Solid electrolytes include, for example, a supporting salt and a polymeric material. For the supporting salt, those mentioned above may be used. For the polymeric material, for example, polyethylene oxide (PEO), polypropylene oxide (PPO), and a copolymer of ethylene oxide and propylene oxide may be mentioned.

To a lead-connecting portion of the positive electrode 11, an end of the positive electrode lead 14 is connected, and to a lead connecting portion of the negative electrode 12, an end of the negative electrode lead 15 is connected. Afterwards, the positive electrode 11, the negative electrode 12, and the separator 13 are stacked, to form an electrode assembly. The electrode assembly is placed in the aluminum laminate bag 17 with both ends of the longitudinal direction thereof open. At the lead portion thereof, one side of the opening of the bag is installed with the gasket 16 and is welded. From the other side of the opening, a non-aqueous electrolyte was dropped. Further, the opening from which the electrolyte is injected is sealed by installing the gasket 16 and welding. The non-aqueous electrolyte battery 1 is made.

The non-aqueous electrolyte battery of the present invention may be used for the same application of conventional non-aqueous electrolyte batteries. For example, in the case when the non-aqueous electrolyte battery of the present invention is a lithium ion battery, it is useful for power sources for mobile electronic devices, transportation devices, and uninterruptible power supplies. Mobile electronic devices include, for example, mobile phones, mobile personal computers, personal data assistants (PDA), and mobile game devices. The non-aqueous electrolyte battery of the present invention may be applied for any of primary batteries and secondary batteries. The non-aqueous electrolyte battery of the present invention may be applied for a wound-type battery in which a positive electrode, a separator, a negative electrode and a separator are wound to form an electrode assembly; and a stack-type battery in which a positive electrode, a separator, and a negative electrode are stacked.

According to the present invention, a separator for non-aqueous electrolyte batteries with excellent resistance to oxidation and high affinity with electrolyte can be provided, and non-aqueous electrolyte batteries can be made to have a high energy density, long life, high reliability, and high output.

In the following, Examples, Comparative Examples, and Experimental Examples are given to describe the present invention in detail.

### EXAMPLE 1

(i) Separator Preparation

A copolymer of tetrafluoroethylene and carbon monoxide was synthesized as in below.

A pressure-resistant container having a reagent inlet was evacuated and backfilled with an inert gas (argon). To this pressure-resistant container, 100 g of degassed water (a solvent for radical polymerization), 36 g of isooctane (a solvent for radical polymerization), and 0.2 g of benzoyl peroxide (an initiator for radical polymerization) were charged. Formic acid was added to the container to adjust the pH of the content to pH 3, and then the container was sealed. Then, from the reagent inlet, 100 g of tetrafluoroethylene was added, and carbon monoxide was charged further until the internal pressure of the pressure-resistant container reached 200 atmospheres. The reaction was carried out at 80° C. for 8 hours, while stirring with a magnetic stirrer. After the reaction, the pressure-resistant container was opened, and the reaction mixture was sufficiently washed with water and dried, thus synthesizing a copolymer for the separator.

The fluorine atom content of the obtained copolymer for the separator was 69 wt %. This implies that 2.8 molecules of tetrafluoroethylene relative to 1 molecule of carbon monoxide was reacted. Also, from analysis by infrared spectroscopy, absorption based on the carbonyl group was confirmed. The synthesized copolymer presumably has the chemical structure formula below.

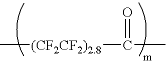

The obtained copolymer was melted at 300° C., and a nonwoven fabric was made by the melt-blown method. The obtained nonwoven fabric was pressed with heat (heating temperature: 270° C., pressure applied: 0.1 MPa), to obtain a microporous film with a thickness of 30 μm and a porosity of 40%.

(ii) Non-Aqueous Electrolyte Preparation

In sulfolane, LiPF₆ was dissolved with a concentration of 1.0 mol/L to prepare a non-aqueous electrolyte.

(iii) Positive Electrode Sheet Preparation

LiNi_{0.5}Mn_{1.5}O₄ powder (positive electrode active material) in an amount of 85 parts by weight, 10 parts by weight of acetylene black (conductive agent), and 5 parts by weight of polyvinylidene fluoride (binder) were mixed, and the obtained mixture was dispersed in dehydrated N-methyl-2-pyrrolidone, to prepare a positive electrode material mixture slurry. This positive electrode material mixture slurry was applied on aluminum foil with a thickness of 15 μm (positive electrode core material), dried, and rolled, to obtain a positive electrode sheet with a thickness of 70 μm.

(iv) Negative Electrode Sheet Preparation

Li₄Ti₅O₁₂ powder (negative electrode active material) in an amount of 75 parts by weight, 20 parts by weight of acetylene black (conductive agent), and 5 parts by weight of polyvinylidene fluoride (binder) were mixed, and the obtained mixture was dispersed in dehydrated N-methyl-2-pyrrolidone, to prepare a negative electrode material mixture slurry. This negative electrode material mixture slurry was applied on copper foil with a thickness of 10 μm (negative electrode core material), dried, and rolled, to obtain a negative electrode sheet with a thickness of 85 μm.

(v) Battery Assembly

The positive electrode sheet and the negative electrode sheet were cut to give a size of 35 mm×35 mm, and an aluminum plate and a copper plate each having a lead were attached on the core material side of the positive electrode sheet and the negative electrode sheet by ultrasonic welding, respectively. The electrode active material layers of the positive and negative electrode sheets were faced with a separator interposed therebetween, and integrated by fixing the aluminum plate and the copper plate with a tape. Then, the integrated assembly was placed in a cylindrical aluminum laminate bag with both ends of the longitudinal direction thereof open. At the lead portion thereof, one side of the opening of the bag was welded. From the other side of the opening, a non-aqueous electrolyte was dropped. Thus assembled battery was charged for 1 hour at a current of 0.1 mA, and degassed for 10 seconds at 10 mmHg. Further, the opening from which the electrolyte was injected was sealed by welding. A battery of Example 1 was thus made.

### EXAMPLE 2

A copolymer for the separator was obtained in the same manner as Example 1, except that hexafluoropropylene was used instead of tetrafluoroethylene. A separator was made in the same manner as Example 1 and a battery of Example 2 was made.

The fluorine atom content in the obtained copolymer for the separator was 71 wt %. This implies that 2.7 molecules of tetrafluoroethylene was reacted per 1 molecule of carbon monoxide. From the analysis using infrared spectroscopy, absorption based on the carbonyl group was confirmed. The synthesized copolymer presumably has the chemical structure formula below. Regarding the position of the trifluoromethyl group, isomers would also exist.

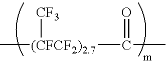

### EXAMPLE 3

A copolymer for the separator was obtained in the same manner as Example 1, except that 1,1-difluoroethylene was used instead of tetrafluoroethylene. A separator was made in the same manner as Example 1 and a battery of Example 3 was made.

The fluorine atom content in the obtained copolymer for the separator was 51 wt %. This implies that 2.7 molecules of 1,1-difluoroethylene was reacted per 1 molecule of carbon monoxide. From the analysis using infrared spectroscopy, the absorption based on the carbonyl group was confirmed. The synthesized copolymer presumably has the chemical structure formula below.

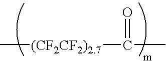

### EXAMPLE 4

A copolymer for the separator was obtained in the same manner as Example 1, except that 1,1,2-trifluoro-1-butene was used instead of tetrafluoroethylene. A separator was made in the same manner as Example 1 and a battery of Example 4 was made.

The fluorine atom content in the obtained copolymer for the separator was 32 wt %. This implies that 3.2 molecules of 1,1,2-trifluoro-1-butene was reacted per 1 molecule of carbon monoxide. From the analysis using infrared spectroscopy, absorption based on the carbonyl group was confirmed. The synthesized copolymer presumably has the chemical structure formula below. Regarding the position of the ethyl group, isomers would also exist.

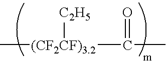

### EXAMPLE 5

A copolymer for the separator was obtained in the same manner as Example 1, except that vinyl fluoride was used instead of tetrafluoroethylene. A separator was made in the same manner as Example 1 and a battery of Example 5 was made.

The fluorine atom content in the obtained copolymer for the separator was 68 wt %. This implies that 3.2 molecules of vinyl fluoride was reacted per 1 molecule of carbon monoxide. From the analysis using infrared spectroscopy, absorption based on the carbonyl group was confirmed. The synthesized copolymer presumably has the chemical structure formula below.

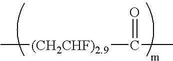

### EXAMPLE 6

A copolymer for the separator was obtained in the same manner as Example 1, except that the pressure of charging carbon monoxide was changed from 200 atmospheres to 100 atmospheres. A separator was made in the same manner as Example 1 and a battery of Example 6 was made.

The fluorine atom content in the obtained copolymer for the separator was 74 wt %. This implies that 10.5 molecules of tetrafluoroethylene was reacted per 1 molecule of carbon monoxide. From the analysis using infrared spectroscopy, absorption based on the carbonyl group was confirmed. The synthesized copolymer presumably has the chemical structure formula below.

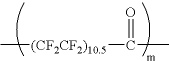

### EXAMPLE 7

A copolymer of tetrafluoroethylene and perfluoroalkoxyethylene (product name: Dyneon (DYNEON™) PFA, manufactured by Sumitomo 3M Limited) was melted at 320° C., and a nonwoven fabric was made by the melt-blown method. The obtained nonwoven fabric was heat-pressed (heating temperature: 270° C., applied pressure: 0.1 MPa), thereby making a separator having a thickness of 30 μm and a porosity of 40%. A battery of Example 7 was made in the same manner as Example 1, except that this separator was used.

Table 1 shows the following of the copolymers for the separator synthesized in Examples 1 to 6; the compositions; the fluorine atom/carbon atom ratio (molar ratio); and the oxygen atom/carbon atom ratio (molar ratio). The compositions were determined by the combustion method, and shown with significant two-digit.

TABLE 1

| | Copolymer for Separator | | |
|---|---|---|---|
| | | Fluorine/Carbon | Oxygen/Carbon |
| | | Ratio | Ratio |
| Example | Composition | (Molar Ratio) | (Molar Ratio) |
| 1 | C_{6.5}O_{1.0}F₁₁ | 1.7 | 0.15 |
| 2 | C_{9.0}O_{1.0}F₁₆ | 1.8 | 0.11 |
| 3 | C_{6.4}H_{5.4}O_{1.0}F_{5.4} | 0.84 | 0.16 |
| 4 | C₁₄H₁₆O_{1.0}F_{9.7} | 0.70 | 0.072 |
| 5 | C_{6.7}H_{8.6}O_{1.0}F_{2.9} | 0.43 | 0.15 |
| 6 | C₂₂O_{1.0}F₄₂ | 1.9 | 0.046 |

### COMPARATIVE EXAMPLE 1

A battery of Comparative Example 1 was made in the same manner as Example 1, except that polypropylene-made separator (thickness 30 μm, porosity 40%) was used.

### COMPARATIVE EXAMPLE 2

A battery of Comparative Example 2 was made in the same manner as Example 1, except that polytetrafluoroethylene-made separator (thickness 30 μm, porosity 40%) was used.

### COMPARATIVE EXAMPLE 3

A battery of Comparative Example 3 was made in the same manner as Example 1, except that a polytetrafluoroethylene-made separator (thickness 30 μm, porosity 40%) with its surface treated with fluorine-type surfactant (product name: Unidyne, manufactured by Daikin Industries, Ltd.) was used.

### EXPERIMENTAL EXAMPLE 1

Batteries of Examples 1 to 7 and of Comparative Examples 1 to 3 were evaluated by the experiments below. The results are shown in Table 2.

### [Initial Discharge Capacity]

Batteries of Examples 1 to 7 and of Comparative Examples 1 to 3 were charged and discharged at a constant current of 100-hour rate under ambient temperature, with a voltage between an upper limit voltage of 3.5 V and a lower limit voltage of 2.0 V. The initial discharge capacity of the battery was determined at this time.

### [Number of Charge and Discharge Cycle]

Batteries of Examples 1 to 7 and of Comparative Examples 1 to 3 were repeatedly charged and discharged at a constant current of 20-hour rate, under an environment temperature of 45° C. with a voltage between an upper limit voltage of 3.5 V and a lower limit voltage of 2.0 V. The battery's life was determined as ended at the point when the discharge capacity declined to 70% of the initial discharge capacity, and the number of charge and discharge cycles (the number of charge and discharge cycles during the battery life) to that point was determined.

### [Discharge Capacity after Storage Test]

Batteries of Examples 1 to 7 and Comparative Examples 1 to 3 were charged until 3.5 V under ambient temperature at 100-hour rate; stored for 7 days at 60° C.; discharged until 2.0 V under an environment temperature restored to ambient temperature, to obtain the discharge capacity, that is, the discharge capacity after storage at 60° C. for 7 days.

TABLE 2

| | | Number of | |
|---|---|---|---|
| | | Charge and | |
| | Initial | Discharge | Discharge |
| | Discharge | Cycle during | Capacity after |
| | Capacity | Battery Life | Storage Test |
| Ex. 1 | 12.4 mAh | 243 | 10.6 mAh |
| Ex. 2 | 12.3 mAh | 221 | 10.4 mAh |
| Ex. 3 | 12.5 mAh | 197 | 5.5 mAh |
| Ex. 4 | 12.3 mAh | 202 | 9.4 mAh |
| Ex. 5 | 12.4 mAh | 188 | 5.3 mAh |
| Ex. 6 | 12.3 mAh | 220 | 10.5 mAh |
| Ex. 7 | 12.2 mAh | 230 | 10.2 mAh |
| Comp. Ex. 1 | 12.2 mAh | 67 | 3.1 mAh |
| Comp. Ex. 2 | 0 mAh | 0 | 0 mAh |
| Comp. Ex. 3 | 12.2 mAh | 210 | 2.5 mAh |

### (Evaluation of Initial Discharge Capacity)

The batteries other than Comparative Example 2 showed the initial discharge capacity of about 12 mAh, whereas the battery of Comparative Example 2 was not able to discharge. This is because by using the polytetrafluoroethylene-made separator, the separator was not wetted by the electrolyte, and the battery did not function as a battery.

### (Evaluation of Charge and Discharge Cycle Number)

Batteries of Examples 1 to 7 and of Comparative Example 3 could achieve about 200 cycles of charge and discharge, whereas the battery of Comparative Example 1 only achieved 67 cycles of charge and discharge. This is probably because the battery of Comparative Example 1 used the polypropylene-made separator, and the separator was oxidized at the charge and discharge potential of LiNi_{0.5}Mn_{1.5}O₂ in the positive electrode to clog the micropores of the separator, causing an increase in the internal resistance.

### (Evaluation in Discharge Capacity after Storage Test)

Any of the batteries of Examples 1 to 2, 4, 6, and 7 achieved the discharge capacity of about 10 mAh, whereas in the batteries of Examples 3 and 5, the discharge capacity was respectively 5.5 mAh and 5.3 mAh. The batteries of Comparative Examples 1 and 3 had further lower discharge capacities, respectively 3.1 mAh and 2.5 mAh. In the battery of Comparative Example 1, the polypropylene-made separator was oxidized by the positive electrode during storage and the discharge capacity decreased. Also, in the battery of Comparative Example 3, the polytetrafluoroethylene-made separator was treated with a surfactant, and repeatedly, this surfactant was oxidized by LiNi_{0.5}Mn_{1.5}O₂ in the positive electrode and this oxidized material was reduced by Li₄Ti₅O₁₂ of the negative electrode, declining the battery discharge capacity.

In the battery of Example 3, in the copolymer for the separator, hydrogen atoms are replaced with the carbon atom at the α-position adjacent to the carbonyl group. This hydrogen atom has a high-acidity, and due to the catalysis of impurities in the electrolyte, condensation reaction of the copolymers for the separator and dehydration involved with the condensation reaction advance, and as a result, water is produced as a by-product, declining the battery capacity. The battery of Example 5 also showed a slight decline in the capacity compared with the battery in Example 1. This is probably because in the battery of Example 5, the ethyl group including carbon atoms with oxidation numbers of two and three is present in the copolymer for the separator, and this ethyl group is oxidized to decline the capacity. Also, in Example 5, the fluorine/oxygen ratio of the copolymer for the separator was 0.43, i.e., below 0.5, and its resistance to oxidation was poor.

The results above show that based on the present invention, a separator for non-aqueous electrolyte batteries with excellent resistance to oxidation and high affinity with electrolytes can be provided.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A separator for a non-aqueous electrolyte battery, comprising a resin film including a copolymer of an olefin compound containing a fluorine atom in its molecule, and a polymerizable organic compound containing an oxygen atom in its molecule.

2. The separator for a non-aqueous electrolyte battery in accordance with claim 1, wherein the copolymer contains at least one carbonyl group in its molecule.

3. The separator for a non-aqueous electrolyte battery in accordance with claim 2, wherein a hydrogen atom is not bonded to the α-position atom adjacent to the carbon atom of the carbonyl group.

4. The separator for a non-aqueous electrolyte battery in accordance with claim 1, wherein a hydrogen atom is not bonded to the carbon atom in the main-chain of the copolymer.

5. The separator for a non-aqueous electrolyte battery in accordance with claim 1, wherein the olefin compound containing a fluorine atom in its molecule is perfluoroolefin, and the polymerizable organic compound containing an oxygen atom in its molecule is carbon monoxide.

6. The separator for a non-aqueous electrolyte battery in accordance with claim 1, wherein an olefin compound is substituted at a terminal position of the copolymer and the olefin compound is perfluoroolefin.

7. The separator for a non-aqueous electrolyte battery in accordance with claim 6, wherein the perfluoroolefin is tetrafluoroethylene.

8. A non-aqueous electrolyte battery including the separator for a non-aqueous electrolyte battery in accordance with claim 1.
